(19) United States
(12) Patent Application Publication
(10) Pub. No.: US 2015/0321726 A1
(43) Pub. Date: Nov. 12, 2015

(54) Rubber mounted drivetrain stabilizer for motorcycles

(71) Applicant: Bruce R. Woltz, Poway, CA (US)

(72) Inventor: Bruce R. Woltz, Poway, CA (US)

(21) Appl. No.: 14/273,972

(22) Filed: May 9, 2014

(51) Int. Cl. B62K 25/28; B62K 11/04

(52) U.S. Cl. CPC B62K 25/283; B62K 11/04

(57) ABSTRACT

A stabilized rubber mounted drivetrain includes a standard rubber mounted drivetrain, further comprising a swingarm pivotal axle, rubber isolators, support brackets; and swingarm stabilizers, which each further include a stabilizer cap, a thrust bearing, and a spacer, such that a swingarm stabilizer is mounted to either end of the swingarm pivot axle. The stabilized rubber mounted drivetrain provides increased stability of the rubber isolators, to ensure the drivetrain is held in place during driving events with lateral forces. The stabilizer cap can include a stabilizer cap head, a stabilizer cap flange, and a stabilizer cap body, and can be machined from one piece of a metal alloy or assembled from separate parts.

### CROSS-REFERENCE TO RELATED APPLICATIONS

N/A

### FIELD OF THE INVENTION

The present invention relates generally to the field of rubber mounted drivetrains for motorcycles, and particularly to devices for stabilizing such rubber mounted drivetrains where the frame supports the drivetrain by holding it between two opposing rubber or elastic mounts

### BACKGROUND OF THE INVENTION

Some motorcycles due to design of the motor cannot completely balance the reciprocating mass inside the motor. To reduce the vibrations, the drivetrain is isolated with flexible couplings made from rubber or other flexible devices. In this context, the drivetrain consists of the motor, transmission, swingarm and a rear drive wheel.

With the driving wheel being suspended by a rubber link, it can move in directions that cause instability issues, which affect Harley Davidson touring machines and other motorcycle makes and models. This driving instability issue is commonly called “bagger wobble” and is characterized such that when a heavy touring motorcycle is placed in a turn, the entire motorcycle can become unstable, entering a momentary wobbling state. The rubber mount allows the rear wheel to twist or move laterally, thereby upsetting the wheel alignment. This condition can also occur when the motorcycle is operated at high speed in a straight line. The isolation systems fail to hold the rear wheel in proper alignment and an oscillation ensues.

Conceived as a new mechanism for drivetrain isolation, the concept of a rubber mounted drivetrain system was originally developed by Norton Motorcycles in the late 1960's and early 1970's.

Harley-Davidson developed their version of the rubber mounted drivetrain system in the late 1970's. The system utilizes a front rubber isolator and in some versions a link to control lateral movement in the front, a link at the top of the motor to keep the drivetrain upright, and rubber isolation devices at the rear near the transmission and swingarm. The rubber isolators in the back attempt to hold the drivetrain in alignment. Its implementation has remained unchanged until today with the exception of various aftermarket accessories.

Examination of the current aftermarket offerings show that they fall into two categories:
a. They attempt to limit the compression of the rubber isolator by adding a stiff plastic piece or a different isolator all together; or
b. They fasten to a cross member or part of the frame, and utilize a link to control the motorcycle drivetrain side-to-side play.

Examples of current aftermarket offerings include:
a. Bagger-Brace manufactured by Phoenix Customs;
b. STA-BO swingarm bushing stabilizers. This aftermarket offering is related to US Patent Application 20090208155, titled “Swingarm bushing stabilizer for Harley-Davidson”;
c. Touring Link chassis stabilizer, manufactured by Progressive Suspension;
d. Glide-Pro Stabilizing System;
e. True-Track swingarm pivot anchors. This aftermarket offering is related to U.S. Pat. No. 7,677,348, titled “Apparatus for deterring instability of a motorcycle”.

Current aftermarket offerings have certain limitations, particularly that they either are simple in design, but do not provide significant added stability, or that they are complex structural components, which are expensive and difficult to install.

As such, considering the foregoing, it may be appreciated that there continues to be a need for novel and improved devices and methods for improving lateral stability of a motorcycle drivetrain system.

### SUMMARY OF THE INVENTION

The foregoing needs are met, to a great extent, by the present invention, wherein in aspects of this invention, enhancements are provided to the existing model of rubber mounted drivetrains, in order to provide much improved stability without having to make complex and costly modifications.

In an aspect, a stabilized rubber mounted drivetrain, as further presented herein, adopts a different approach to motorcycle stability in that it utilizes the opposite side of the frame to keep the driveline from moving laterally. This better distribution of load minimizes flex between the motorcycle chassis and the drivetrain.

In an aspect, the stabilized rubber mounted drivetrain stiffens the rear driveline connection to the frame for Harley Davidson Touring bikes and other manufacturer's motorcycles that utilize compressed rubber suspension devices between the motorcycle chassis and the rear swingarm mount. When the motorcycle is in a turn, the lateral forces push against only one side of the frame. This force can cause the one side of the frame to flex. The stabilized rubber mounted drivetrain ties both sides of the frame together through the swingarm pivot axle, so that both sides of the frame support the load. The system also increases straight-line stability, minimizing risk of small side forces starting an oscillation.

In a related aspect, the stabilized rubber mounted drivetrain, in addition to a standard rubber mounted drivetrain, includes two additional specialized fasteners, called swingarm stabilizers, which attach to the ends of the swingarm pivot axle, and can further contain some thrust bearings and shims to adjust the clearance between the fasteners and the thrust bearings.

In yet a related aspect, the stabilized rubber mounted drivetrain ties both sides of the motorcycle frame together through the swingarm pivot axle. Two swingarm stabilizers including thrust bearings tie the two sides. When the motorcycle is traveling straight, the swingarm stabilizers have no load on them. As the motorcycle enters a turn, a sideways force may cause the drivetrain to move slightly. The swingarm stabilizers distribute part of the load to the other side of the motorcycle frame, thereby reducing chassis to drivetrain flex and helping to stabilize the motorcycle.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a rear cross-sectional view, illustrating a stabilized rubber mounted drivetrain, according to an embodiment of the invention.

FIG. 2 is a rear cross-sectional view, illustrating a swingarm stabilizer, according to an embodiment of the invention.

FIG. 3 is an outer-side perspective view of a swingarm stabilizer, according to an embodiment of the invention.

FIG. 4 is an inner-side perspective view of a swingarm stabilizer, according to an embodiment of the invention.

FIG. 5 is a right-side perspective view of a swingarm stabilizer mounted on a motorcycle, according to an embodiment of the invention.

FIG. 6 is a left-side perspective view of a swingarm stabilizer mounted on a motorcycle, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

In the following, a drivetrain of a motorcycle shall be defined to include the motor, transmission, swingarm, and a rear drive wheel.

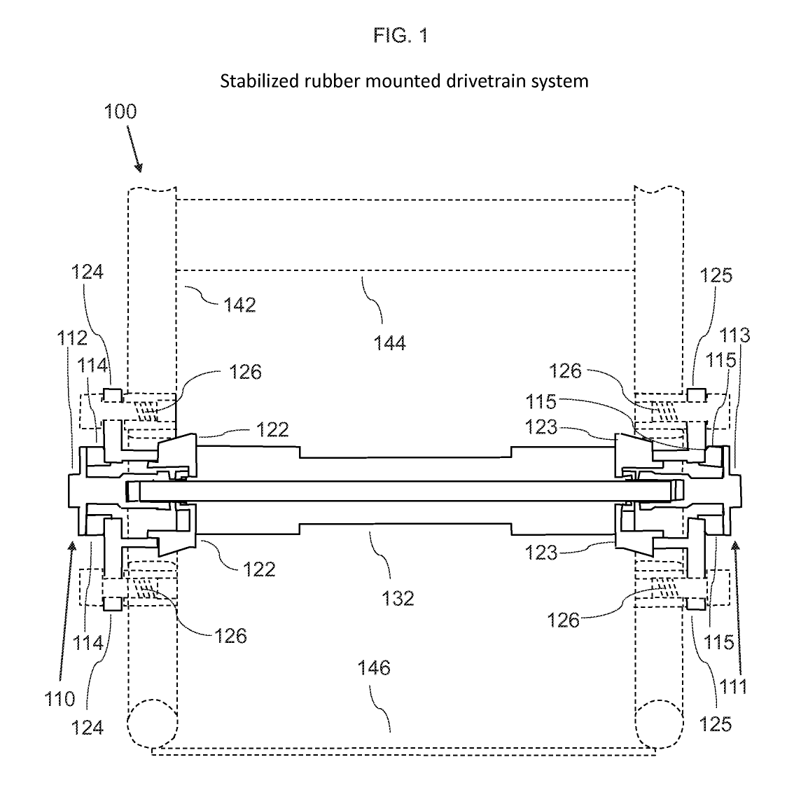

In the following, we describe the structure of an embodiment of a stabilized rubber mounted drivetrain 100 with reference to FIG. 1, in such manner that like reference numerals refer to like components throughout; a convention that we shall employ for the remainder of this specification.

In an embodiment, FIG. 1 illustrates a rear cross-sectional view of a stabilized rubber mounted drivetrain 100 for mounting on a motorcycle, comprised of:

a. A standard rubber mounted drivetrain, further comprising
i. A swingarm pivotal axle 132; which serves as a pivotal axle for swingarm of the motorcycle;
ii. Rubber isolators 122 123; comprising a left rubber isolator 122 and a right rubber isolator 123;
iii. Support brackets 124 125, comprising a left support bracket 124 and a right support bracket 125, wherein the support brackets are connected to the motorcycle frame 142 with bolts 126;
wherein the rubber isolators are mounted tightly between the swingarm pivotal axle 132 and the support brackets 124 125, such that the rubber isolators 122 123 secure and hold the swingarm pivotal axle 132 in place, while providing a rubberized isolation reducing transfer of vibrations from the swingarms, transmission, and swingarm pivotal axle 132 to a motorcycle frame 142;

b. swingarm stabilizers 110 111, comprising:
i. a left swingarm stabilizer 110, further comprising:
   1. a left stabilizer cap 112; and
   2. a left thrust bearing 114;
   wherein an inner end of the left stabilizer cap 112 can be connected to the left end point of the swingarm pivotal axle 132; such that the left thrust bearing 114 is held in place by a connection to an outer end of the left stabilizer cap 112, such that an inner surface of the left thrust bearing 114 is adjacent to an outer surface of the left support bracket 124, preventing lateral movement of the left support bracket 124, but allowing the left support bracket 124 to move substantially freely in the vertical plane; thereby providing an increased stability of the left rubber isolator 122, reducing the risk that the left rubber isolator 122 becomes unloaded;
   whereby the left rubber isolator 122 can be held in place during driving events with strong lateral forces, such as during high-speed turns.
ii. a right swingarm stabilizer 111, further comprising:
   1. a right stabilizer cap 113; and
   2. a right thrust bearing 115;
   wherein an inner end of the right stabilizer cap 113 can be connected to the right end point of the swingarm pivotal axle 132, such that the right thrust bearing 115 is held in place by a connection to an outer end of the right stabilizer cap 112, such that an inner surface of the right thrust bearing 114 is adjacent to an outer surface of the right support bracket 124, preventing lateral movement of the right support bracket 125, but allowing the right support bracket 125 to move substantially freely in the vertical plane; thereby providing an increased stability of the right rubber isolator 123, reducing the risk that the right rubber isolator 123 becomes unloaded;
   whereby the right rubber isolator 123 can be held in place during driving events with strong lateral forces, such as during heavy turns.

In typical standard motorcycles, the motorcycle frame 142, can further comprise:

a. An upper cross brace 144; and

b. A lower cross brace 146;
wherein the upper cross brace 144 and the lower cross brace 146 serve to stabilize the motorcycle frame 142.

During turning maneuvers, the motorcycle section can flex due to lateral forces. In a standard configuration with a standard rubber mounted drivetrain, without swingarm stabilizers 110 111 mounted, only one side of the motorcycle frame 142 supports the load. In this standard configuration, the isolator is typically mounted with a slip fit feature, which can cause the rubber isolators 122 123 to become unloaded during strong lateral load while turning, which can further cause the rubber isolators 122 123 to slip, whereby the swingarm pivotal axle 132 becomes unstable. This sequence of events can directly cause directional instability during high-speed turns, which can be so severe that it can cause a driver to lose control of the motorcycle.

In typical variants of the standard configuration of a rubber mounted swingarm axle, a specially designed nut applies pressure to the rubber isolators 122 123 and thereby holds the rubber isolators 122 123 in place. In all such standard configurations, however, the nut does not provide any connection to or any stabilization of the support brackets 124 125.

In typical variants of a standard rubber mounted drivetrain, the support bracket 124 125 may be designed as a separate part, which is connected to the motorcycle frame 142. However, in alternative variants, the support bracket 124 125 may be an integral part of the motorcycle frame 142. Furthermore, in yet other alternative variants, the design of the motorcycle frame 142 may be configured such that it includes the function of the support bracket 124 125, without the support bracket 124 125 being identifiable as a component of the motorcycle frame 142.

Both the upper cross brace 144 and the lower cross brace 146 can typically be mounted 6-8 inches from the swingarm pivotal axle 132, respectively above and below the swingarm pivotal axle 132.

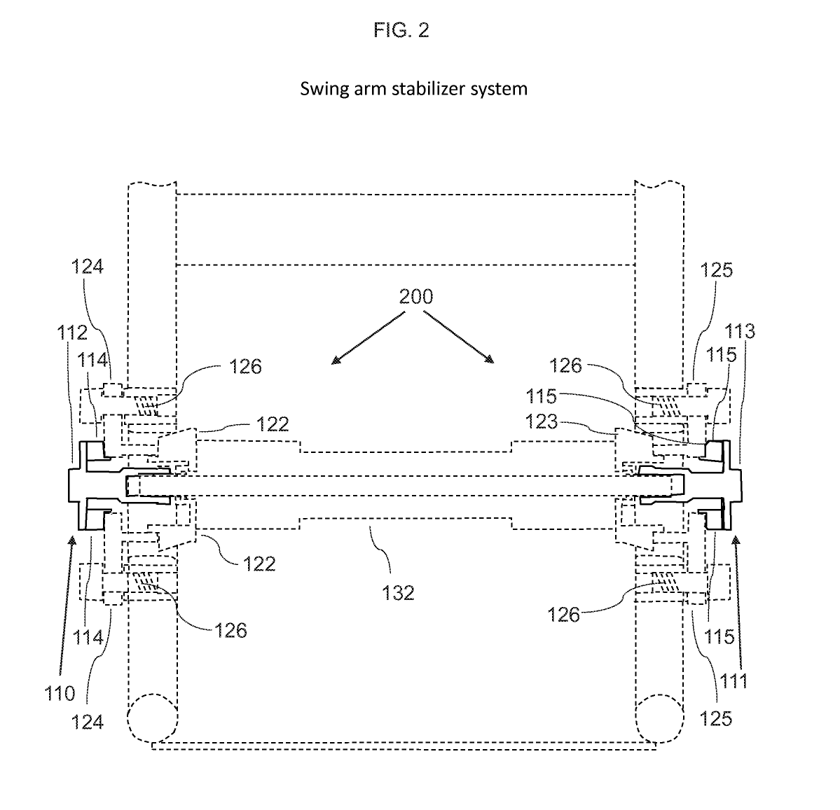

In an embodiment, as illustrated in FIG. 2, a swingarm stabilizer system 200, can comprise:

a. a left swingarm stabilizer 110, further comprising:
i. a left stabilizer cap 112; and
ii. a left thrust bearing 114;
wherein the left stabilizer cap 112 can be connected to the left end point of the swingarm pivotal axle 132; such that the left thrust bearing 114 is held in place by a connection to an outer end of the left stabilizer cap 112, such that an inner surface of the left thrust bearing 114 is adjacent to an outer surface of the left support bracket 124, preventing lateral movement of the left support bracket 124, but allowing the left support bracket 124 to move substantially freely in the vertical plane; thereby providing an increased stability of the left rubber isolator 122, reducing the risk that the left rubber isolator 122 becomes unloaded;
whereby the left rubber isolator can be held in place during driving events with strong lateral forces, such as during high-speed turns.

b. a right swingarm stabilizer 111, further comprising:
i. a right stabilizer cap 113; and
ii. a right thrust bearing 115;
wherein the right stabilizer cap 113 can be connected to the right end point of the swingarm pivotal axle 132; such that the right thrust bearing 115 is held in place by a connection to an outer end of the right stabilizer cap 113, such that an inner surface of the right thrust bearing 115 is adjacent to an outer side of the right support bracket 125, preventing lateral movement of the right support bracket 125, but allowing the right support bracket 125 to move substantially freely in the vertical plane; thereby providing an increased stability of the right rubber isolator 123, reducing the risk that the right rubber isolator 123 becomes unloaded;
whereby the right rubber isolator 123 can be held in place during driving events with strong lateral forces, such as during heavy turns;

In a related embodiment, the swingarm stabilizers 110 111 can replace standard nuts on a standard rubber mounted drivetrain.

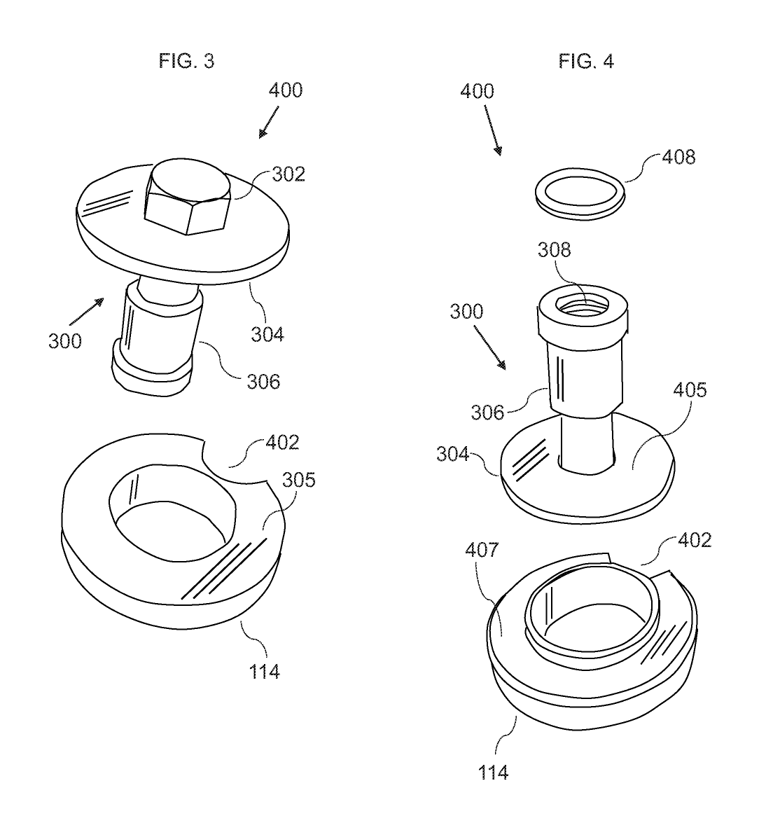

In a related embodiment, FIG. 3 and FIG. 4 show perspective views of a swingarm stabilizer 400, which could be installed either as a left swingarm stabilizer 110, or a right swingarm stabilizer 111.

In a related embodiment, FIG. 3 and FIG. 4 show perspective views of a stabilizer cap 300, which could function either as a left stabilizer cap 112, or a right stabilizer cap 113.

In a related embodiment, FIG. 3 shows an outer-side perspective view of a stabilizer cap 300, further comprising:
a. A stabilizer cap head 302, which can be configured as a bolt head to allow for easy use with a wrench tool;
b. A stabilizer cap flange 304; wherein the stabilizer cap flange 304 is designed to hold the thrust bearing 114 115 in place;
c. A stabilizer cap body 306; wherein the inner end of the stabilizer cap body 306 can connect to the either the right or left end of a swingarm pivotal axle 132;
wherein the stabilizer cap head 302, is connected to the outer end of the stabilizer cap body 306; and the stabilizer cap flange 304 is mounted on the inside of the stabilizer cap head 302, towards the outer end of the stabilizer cap body 305, such that the stabilizer cap flange 304 is designed to hold the thrust bearing 114 115 in place, when the stabilizer cap flange 304 is attached to an end of the swingarm pivotal axle 132, with the thrust bearing 114 115 mounted between the stabilizer cap flange 304 and the thrust bearing 114 115.

In a related embodiment, FIG. 4 shows an inner-side perspective view of a stabilizer cap 300, wherein the inner end of the stabilizer cap body 306 further comprises a threaded cavity 308, such that the threaded cavity 308 can be screwed on a threaded or bolt end of the swingarm pivotal axle 132.

In a related embodiment, the swingarm stabilizer 400 can further comprise a spacer, or shim, which can be positioned on the end of the swingarm pivotal axle 132, between the swingarm pivotal axle 132 and the inner end of the stabilizer cap body 306, in order to adjust the position of the swingarm stabilizer 400.

In various related embodiments, the stabilizer cap 300 can be machined from one piece of a metal alloy, such that the stabilizer cap head 302, the stabilizer cap flange 304, and the stabilizer cap body 306 are all integral parts of the machined piece. The metal alloy can for example be a high-strength steel alloy commonly used for similar automotive parts, such as load bearing fasteners.

In various other related embodiments, the stabilizer cap 300, can be assembled from separate components comprising respectively the stabilizer cap head 302, the stabilizer cap flange 304, and the stabilizer cap body 306, which can each be made of metal alloys, which can be either the same or different metal alloys. For example, the stabilizer cap body 306 can further include an outer threaded cavity, such that a stabilizer cap head 302 in the form of a bolt, can be screwed into the outer end of the stabilizer cap body 306. A circular spacer, functioning as the stabilizer cap flange 304, can then be secured between the bolt cap head 302 and the stabilizer cap body 306.

In various related embodiments, the thrust bearings 114 115, can be made of a suitable plastic material, such that the inner surface of the thrust bearings 114 115 have a low coefficient of friction, and thereby can allow vertical movement of the rubber isolators 122 123, while preventing or minimizing lateral movement. Such a suitable plastic material can for example have a tensile strength in a range of 10,000-14,000 psi, a Rockwell hardness rating of R 108-R 120, and a low coefficient of friction in a range of 0.05-0.20. Examples of such suitable plastic materials include MDS-Filed Nylon 6/6 and Delrin Acetal Resin.

In a related embodiment, FIG. 3 and FIG. 4 show perspective views of a thrust bearing 114, which could be installed either as a left thrust bearing 114, or a right thrust bearing 115.

In a related embodiment, FIG. 3 shows an outer-side perspective view of a thrust bearing 114 115, such that the shape of the inner surface 407 of the thrust bearing 114, as shown in FIG. 4, is configured to match with a particular shape of an outer surface of an existing support bracket 124 125.

In a related embodiment, FIG. 4 shows an inner-side perspective view of the thrust bearing 114 115, such that the shape of the outer surface 305 of the thrust bearing 114 115 is configured to match with the shape of the inner surface 405 of the stabilizer cap flange 304.

In a further related embodiment, the thrust bearing 114 115 can have an aperture 402, including a cutout, to allow for fitting with cables, wires, or other attachments that connect to the support bracket 124 125, or the adjacent areas.

In a further related embodiment, the swingarm stabilizer 400 can further comprise a spacer 408, such that the spacer 408 is mounted on an end of the swingarm pivotal axle 132, inside the inner end of the stabilizer cap 112 113, whereby the spacer 408 adjusts the clearance between the thrust bearing 114 115 and the support bracket 124 125.

In a related embodiment, the swingarm stabilizer 200 components shown in FIGS. 3 and 4 are configured with specific shapes to match a standard rubber mounted drivetrain of various model series of Harley Davidson touring motorcycles.

In various alternative related embodiments, the specific shape of the components of the swingarm stabilizer 200 can be configured with specific shapes to match other motorcycle original equipment manufacturers pre-existing standard rubber mounted drivetrains, or to match a new design for standard rubber mounted drivetrain, as part of a new design for a stabilized rubber mounted drivetrain 100.

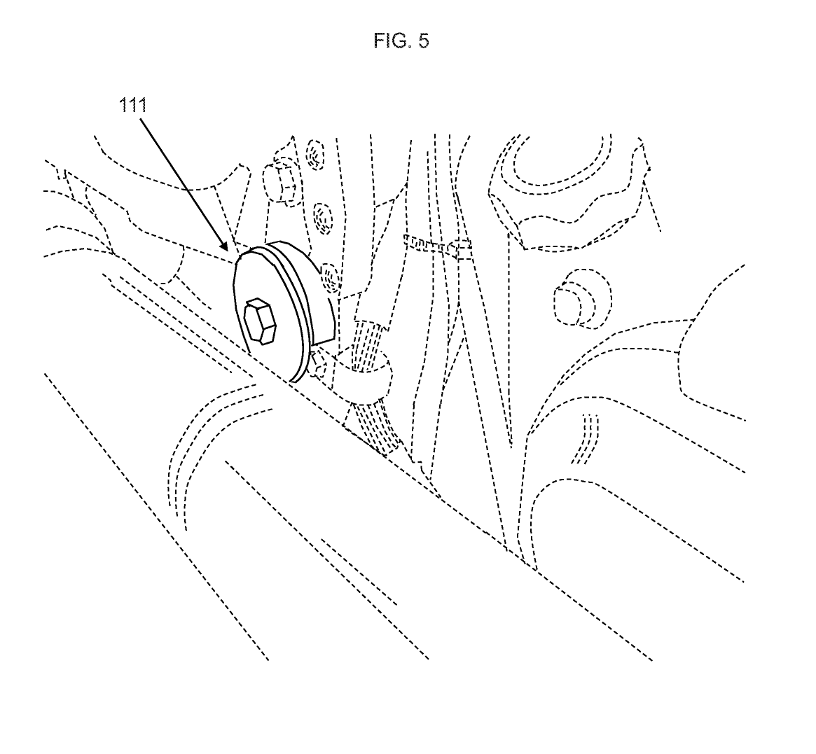

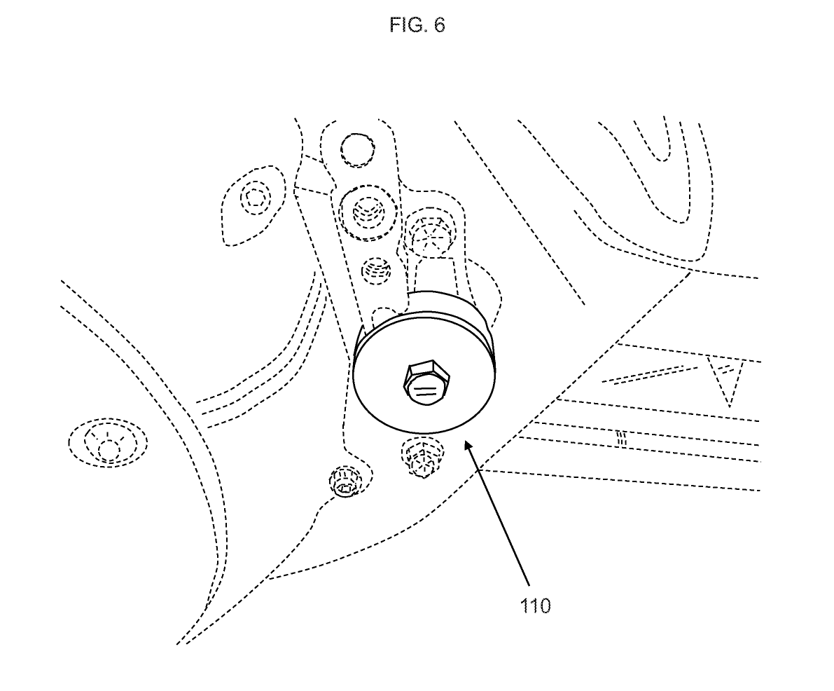

In a related embodiment, FIG. 5 shows a right-side perspective view of a right swingarm stabilizer 111 mounted on the right side of a motorcycle.

In a related embodiment, FIG. 6 shows a left-side perspective view of a left swingarm stabilizer 110 mounted on the left side of a motorcycle.

In related embodiments, engine stabilizers, including stabilizer cap and thrust bearing, may also be used on other rubber isolated mounting points, which are part of a standard rubber mounted drivetrain system. This can for example include front and rear engine mounts, such as for example used on various 2009 and newer Harley-Davidson touring models.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A stabilized rubber mounted drivetrain for mounting on a motorcycle, comprised of:
a) a standard rubber mounted drivetrain, further comprising
a swingarm pivotal axle, which is configured as a pivotal axle for swingarms of the motorcycle; and
at least one rubber isolator;
wherein the rubber isolator is mounted adjacent to an end of the swingarm pivotal axle and a motorcycle frame, such that the rubber isolators secure and hold the swingarm pivotal axle in place, while providing a rubberized isolation reducing transfer of vibrations from the drivetrain to the motorcycle frame;
a) at least one swingarm stabilizer, comprising:
a stabilizer cap; and
a thrust bearing;
wherein an inner end of the stabilizer cap is connected to an end of the swingarm pivotal axle, such that the thrust bearing is held in place by a connection to an outer end of the stabilizer cap, such that an inner surface of the thrust bearing prevents lateral movement of the rubber isolator, but allows the rubber isolator to move substantially freely in the vertical plane; whereby the swingarm stabilizer provides an increased stability of the drivetrain.

2. The stabilized rubber mounted drivetrain of claim 1, wherein the standard rubber mounted drivetrain further comprises at least one support bracket, such that the thrust bearing is held in place by a connection to an outer end of the stabilizer cap, such that an inner surface of the thrust bearing is adjacent to an outer surface of the support bracket, such that the thrust bearing prevents lateral movement of the support bracket, but allows the support bracket to move substantially freely in the vertical plane; whereby the swingarm stabilizer provides an increased stability of the rubber isolator, reducing the risk that the rubber isolator becomes unloaded; whereby further the rubber isolator is held in place during driving events with strong lateral forces.

3. The stabilized rubber mounted drivetrain of claim 1, wherein the at least one rubber isolator is comprised of a left rubber isolator and a right rubber isolator, and wherein further the at least one swingarm stabilizer is comprised of a left swingarm stabilizer and a right swingarm stabilizer.

4. The stabilized rubber mounted drivetrain of claim 1, wherein the stabilizer cap further comprises:
a) a stabilizer cap head;
b) a stabilizer cap flange, wherein the stabilizer cap flange is configured to hold the thrust bearing in place;
c) a stabilizer cap body, wherein the inner end of the stabilizer cap body is connected to an end of the swingarm pivotal axle;
wherein the stabilizer cap head is connected to an outer end of the stabilizer cap body; and the stabilizer cap flange is mounted on an inside of the stabilizer cap head, towards an outer end of the stabilizer cap body, such that the stabilizer cap flange is configured to hold the thrust bearing in place, when the stabilizer cap flange is attached to an end of the swingarm pivotal axle, with the thrust bearing mounted between the stabilizer cap flange and the rubber isolator.

5. The stabilized rubber mounted drivetrain of claim 4, wherein the stabilizer cap head is configured as a bolt head, whereby a wrench tool can be used to attach the stabilizer cap to the swingarm pivotal axle.

6. The stabilized rubber mounted drivetrain of claim 2, wherein the swingarm stabilizer further comprises a spacer, such that the spacer is mounted on the end of the swingarm pivotal axle, between the swingarm pivotal axle and the stabilizer cap, whereby the spacer adjusts the clearance between the thrust bearing and the support bracket.

7. The stabilized rubber mounted drivetrain of claim 1, wherein the stabilizer cap is machined from one piece of a metal alloy.

8. The stabilized rubber mounted drivetrain of claim 1, wherein the thrust bearing further comprises an aperture, whereby the aperture allows for fitting with cables, wires, or other attachments that connect to the swingarm pivotal axle, a support bracket, or the adjacent areas.

9. The stabilized rubber mounted drivetrain of claim 1, wherein the thrust bearing is made of a suitable plastic material.

10. A swingarm stabilizer, comprising:
a) a stabilizer cap; and
b) a thrust bearing;
wherein the stabilizer cap is configured to connect to an end of a swingarm pivotal axle of a motorcycle, which is equipped with a standard rubber mounted drivetrain, such that the thrust bearing is held in place by a connection to an outer end of the stabilizer cap, such that an inner surface of the thrust bearing prevents lateral movement of the rubber isolator, but allows the rubber isolator to move substantially freely in the vertical plane;
whereby the swingarm stabilizer provides an increased stability of the standard rubber mounted drivetrain.

11. The swingarm stabilizer of claim 10, wherein the stabilizer cap further comprises:
a) a stabilizer cap head;
b) a stabilizer cap flange, wherein the stabilizer cap flange is configured to exert pressure on the thrust bearing;
c) a stabilizer cap body, wherein the inner end of the stabilizer cap body is configured to connect to an end of the swingarm pivotal axle;
wherein the stabilizer cap head is connected to an outer end of the stabilizer cap body; and the stabilizer cap flange is mounted on an inside of the stabilizer cap head, towards an outer end of the stabilizer cap body, such that the stabilizer cap flange is configured to hold the thrust bearing in place, when the stabilizer cap flange is attached to an end of the swingarm pivotal axle, with the thrust bearing mounted between the stabilizer cap flange and the rubber isolator.

12. The swingarm stabilizer of claim 10, wherein the swingarm stabilizer is configured such that the thrust bearing is held in place by a connection to an outer end of the stabilizer cap, such that an inner surface of the thrust bearing is adjacent to an outer surface of a support bracket, such that the thrust bearing prevents lateral movement of the support bracket, but allows the support bracket to move substantially freely in the vertical plane; whereby the swingarm stabilizer provides an increased stability of the rubber isolator, reducing the risk that the rubber isolator becomes unloaded; whereby further the rubber isolator is held in place during driving events with strong lateral forces.

13. The swingarm stabilizer of claim 12, wherein the swingarm stabilizer further comprises a spacer, such that the spacer is mounted on the end of the swingarm pivotal axle, between the swingarm pivotal axle and the stabilizer cap, whereby the spacer adjusts the clearance between the thrust bearing and the support bracket.

14. The swingarm stabilizer of claim 11, wherein the stabilizer cap head is configured as a bolt head, whereby a wrench tool can be used to attach the stabilizer cap to the swingarm pivotal axle.

15. The swingarm stabilizer of claim 10, wherein the stabilizer cap is machined from one piece of a metal alloy.

16. The swingarm stabilizer of claim 10, wherein the thrust bearing further comprises an aperture, whereby the aperture allows for fitting with cables, wires, or other attachments that connect to the swingarm pivotal axle, a support bracket, or the adjacent areas.

17. The swingarm stabilizer of claim 10, wherein the thrust bearing is made of a suitable plastic material.
